(19) United States
(12) Patent Application Publication
(10) Pub. No.: US 2009/0278774 A1
(43) Pub. Date: Nov. 12, 2009

(54) CONTENT-ADAPTIVE ADJUSTMENT SYSTEM AND METHOD

(76) Inventors: SHING-CHIA CHEN, Tainan (TW); Ling-Hsiu Huang, Tainan (TW)

Correspondence Address: STOUT, UXA, BUYAN & MULLINS LLP, 4 VENTURE, SUITE 300, IRVINE, CA, 92618, US

(21) Appl. No.: 12/115,736

(22) Filed: May 6, 2008

(51) Int. Cl. G09G 3/32

(52) U.S. Cl. 345/83

(57) ABSTRACT

A content-adaptive adjustment system and method for a light-emitting display is disclosed. An analysis unit analyzes, for example, the average data intensity/power consumption and the data distribution of the image data to be displayed. An adjustment unit then adjusts, for example, the pixel values of the image data or the drive levels of the light-emitting display according to the analyzed data distribution, such that the consumed power in the light-emitting display could be considerably reduced.

### BACKGROUND OF THE INVENTION

1. Field of the Invention

The present invention generally relates to organic light-emitting diode (OLED) display, and more particularly to adjusting the driving current of the OLED display.

2. Description of the Prior Art

The organic light-emitting diode (OLED) has recently received more attention and application in the field of the flat panel display, in television screens, computer displays, and portable electronic device screens. A primary benefit of the OLED over other flat panel displays is that the OLED itself emits light of different colors and therefore does not involve the backlight and color filter as required, for example, in the liquid crystal display (LCD). Further, the OLED display can be more effectively manufactured in process and in cost. Nevertheless, the significant drawback of the OLED is the limited lifetime of the organic materials prone to degradation compared to the LCD, for example.

The OLED-based display is operated in a current driving manner, and therefore the resistance in the circuit causes a significant voltage drop (or IR drop) problem and heat loss issue. Accordingly, the operation efficiency, particularly the power efficiency, of the OLED-based display becomes low.

For the foregoing reasons, a need has arisen to propose a novel scheme for the OLED display that not only decreases the voltage drop problem and the heat loss issue, but also increases the power efficiency to save power consumption.

### SUMMARY OF THE INVENTION

In view of the foregoing, it is an object of the present invention to alleviate the voltage drop problem and the heat loss issue, to save power consumption, and to lengthen the lifetime of the OLED display.

According to the embodiment of the present invention, a content-adaptive adjustment system and method for a light-emitting display is disclosed. An analysis unit analyzes, for example, the average data intensity/power consumption and the data distribution of the image data to be displayed. An adjustment unit then adjusts, for example, the pixel values of the image data or the drive levels of the light-emitting display according to the analyzed data distribution, such that the consumed power in the light-emitting display could be considerably reduced.

### BRIEF DESCRIPTION OF THE DRAWINGS

FIG. 1A illustrates a content-adaptive adjustment system for an organic light-emitting diode (OLED) display according to one embodiment of the present invention;

FIG. 1B illustrates a flow of the analysis unit in FIG. 1A;

FIG. 2A and FIG. 2B show exemplary and simplified examples illustrating the data distributions analysis in FIG. 1B;

FIG. 3 shows exemplary tone curves according to one embodiment of the present invention; and

FIG. 4 shows an exemplary reference-voltage generating circuit according to another embodiment of the present invention.

### DETAILED DESCRIPTION OF THE INVENTION

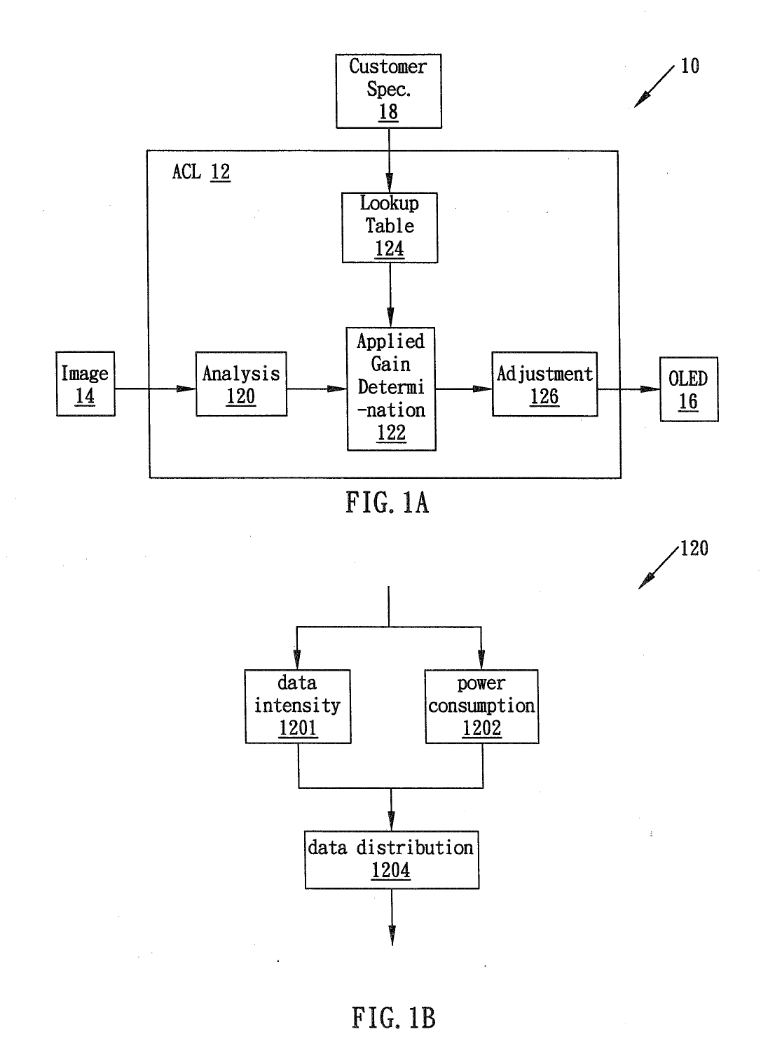

FIG. 1A illustrates a content-adaptive adjustment system 10 for an organic light-emitting diode (OLED) display according to one embodiment of the present invention. While the OLED display is addressed here, the content-adaptive adjustment system 10 of the present invention can be adapted to another emissive-type display that itself emits light without requiring a backlight or other light source. The content-adaptive adjustment system 10 includes an automatic current limiter (ACL) 12, which receives image data 14 and then outputs the resultant image on the OLED display 16.

The ACL 12 includes an analysis unit 120 for analyzing characteristics of the received image data. In this specification, the term unit is configured to denote a circuit, a piece of program, or their combination. FIG. 1B illustrates a flow of the analysis unit 120 according to one embodiment of the present invention. In the embodiment, the intensity of the received image data 14 is analyzed in step 1201, to obtain, for example, the average data intensity of a frame. Alternatively, the power consumption of the OLED display 16 is analyzed in step 1202, to obtain, for example, the average power consumption of a frame.

According to the embodiment of the present invention, customer specification or requirement (block 18) is provided. In the embodiment, the image data, among others, provided by the customer are examined. The examination of the image data is usually performed off line. As a result, a number of data pairs are obtained (in block 124), each representing average data intensity and its associated gain. The gain value is, for example, a positive number less than 1. In general, greater average data intensity associates with a lesser gain, and vice versa. These data pairs are stored, for example, as a lookup table in a storage device. Subsequently, a determination unit 122 determines the gain applied to each pixel value according to the average data intensity (from step 1201) or the average power consumption (from step 1202), with respect to the lookup table 124. In other words, given an average value from the block 120, the determination unit 122 then retrieves an associated gain value from the lookup table 124.

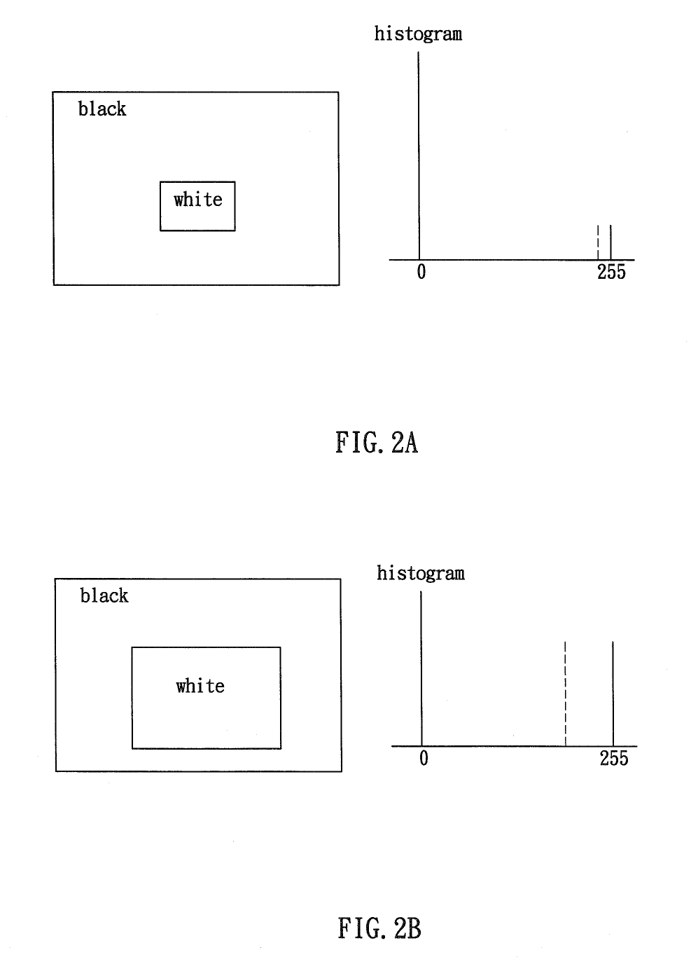

Referring back to FIG. 1B, in step 1204, the image data may be subjected to further analysis to determine data distribution. FIG. 2A and FIG. 2B show exemplary and simplified examples illustrating the data distributions analysis. For the case exemplified in FIG. 2A, the ratio between the white area and the black area is small (e.g., 0.05), or the overall average data intensity is small, as represented in the accompanied histogram. On the other hand, for the case exemplified in FIG. 2B, the ratio between the white area and the black area is large (e.g., about 1), or the overall average data intensity is large, as represented in the accompanied histogram. Subsequently, an adjustment unit 126 (FIG. 1A) is utilized to adjust the pixel values according to the data distribution. For better understanding the adjustment, please refer to the case illustrated in FIG. 2A. As the ratio of the white area to the black area in FIG. 2A is determined to be very small in the step 1204 (FIG. 1B), the adjustment unit 126 then performs some adjustment, for example by using conventional digital image processing technique, on the white pixel values. The resultant adjusted pixel values are shown as dotted line in the accompanied histogram. Accordingly, the white pixel values are shifted somewhat to grey pixel values. As the OLED display inherently has a higher contrast compared to other flat panel display, the adjustment in FIG. 2A has little visual effect on the contrast of the image perceived by human eyes, but this adjustment somewhat reduces the driving current, and thus the consumed power. This reduction in consumed power not only alleviates the heat loss issue, but also lengthens the lifetime of the OLED display. Please further refer to the case illustrated in FIG. 2B. As the ratio of the white area to the black area in FIG. 2B is determined to be large enough in the step 1204 (FIG. 1B), the adjustment unit 126 then performs substantive adjustment on the white pixel values with adjustment extent greater than that in FIG. 2A. The resultant adjusted pixel values are shown as dotted line in the accompanied histogram. As discussed above, the adjustment in FIG. 2B has little visual effect on the contrast of the image perceived by human eyes, but substantially reduces the driving current, and thus the consumed power.

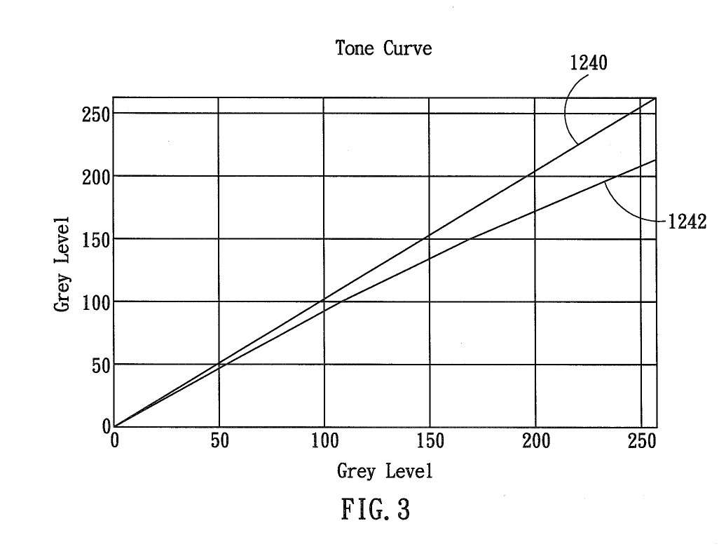

The performance of the adjustment unit 126 may be, in general, represented by a tone curve as exemplified in FIG. 3. In the figure, the horizontal axis represents the tones of the original input image, and the vertical axis represents the tones of the adjusted output image. The dotted linear line 1240 indicates that no adjustment is done. The exemplary curve 1242 indicates that the high grey levels are tone remapped to a lower level, while the low grey levels are substantially maintained.

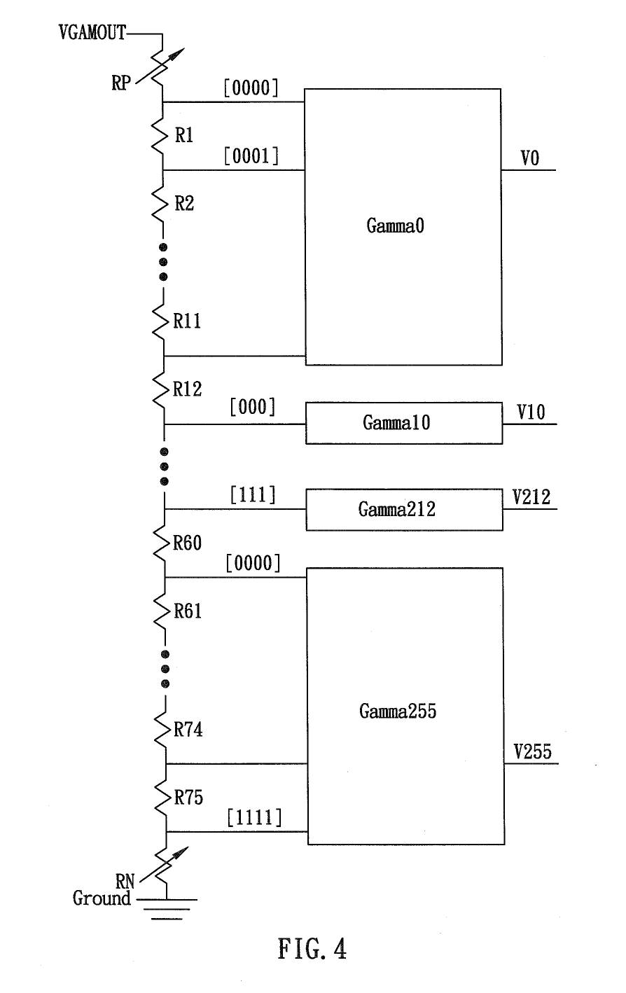

According to another embodiment of the present invention, the adjustment unit 126, in accordance with the results of the analysis unit 120, is utilized to adjust the drive levels of a reference-voltage generating circuit of a display driver, instead of adjusting the pixel values in the previous embodiment. FIG. 4 shows an exemplary reference-voltage generating circuit or a Gamma generating circuit, in which the reference voltages are generated according to the results of the analysis unit 120. The drive-level adjustment in the adjustment unit 126 or the reference-voltage generating circuit is performed in a manner such that it has little visual effect on the contrast of the image perceived by human eyes, while substantially reduces the consumed power. This reduction in consumed power not only alleviates the heat loss issue, but also lengthens the lifetime of the OLED display. Compared to the previous embodiment, the present embodiment performs the content-adaptive adjustment on the drive levels rather than pixel values as in the previous embodiment. The present embodiment is implemented by an analog circuit rather than a digital image processor as in the previous embodiment.

Although specific embodiments have been illustrated and described, it will be appreciated by those skilled in the art that various modifications may be made without departing from the scope of the present invention, which is intended to be limited solely by the appended claims.

What is claimed is:

1. A content-adaptive adjustment system for a light-emitting display, comprising:
an analysis unit for analyzing image data; and
an adjustment unit for adjusting the image data or the light-emitting display according to the analyzed image data, such that consumed power in the light-emitting display is reduced.

2. The content-adaptive adjustment system according to claim 1, wherein said light-emitting display is an organic light-emitting diode (OLED) display.

3. The content-adaptive adjustment system according to claim 1, wherein said analysis unit performs a step of:
analyzing intensity of the image data.

4. The content-adaptive adjustment system according to claim 3, wherein an average intensity value of the image data in a frame is obtained.

5. The content-adaptive adjustment system according to claim 3, wherein said analysis unit performs a further step of:
analyzing data distribution of the image data.

6. The content-adaptive adjustment system according to claim 1, wherein said analysis unit performs a step of:
analyzing power consumption in the light-emitting display.

7. The content-adaptive adjustment system according to claim 6, wherein an average power consumption value in the light-emitting display is obtained.

8. The content-adaptive adjustment system according to claim 6, wherein said analysis unit performs a further step of:
analyzing data distribution of the image data.

9. The content-adaptive adjustment system according to claim 1, further comprising a determination unit for determining a gain applied to each pixel value according to analyzed intensity of the image data or analyzed power consumption in the light-emitting display.

10. The content-adaptive adjustment system according to claim 9, further comprising a lookup table which includes a plurality of data pairs, each representing the analyzed intensity or the analyzed power consumption and its associated gain.

11. The content-adaptive adjustment system according to claim 1, wherein said adjustment unit comprises a tone curve for remapping the image data.

12. The content-adaptive adjustment system according to claim 1, wherein said adjustment unit adjusts drive levels of a reference-voltage generating circuit of a display driver according to the analyzed image data.

13. A content-adaptive adjustment method for a light-emitting display, comprising:
analyzing image data; and
adjusting the image data or the light-emitting display according to the analyzed image data, such that consumed power in the light-emitting display is reduced.

14. The content-adaptive adjustment method according to claim 13, wherein said light-emitting display is an organic light-emitting diode (OLED) display.

15. The content-adaptive adjustment method according to claim 13, wherein intensity of the image data is analyzed.

16. The content-adaptive adjustment method according to claim 15, wherein an average intensity value of the image data in a frame is obtained after the image data has been analyzed.

17. The content-adaptive adjustment method according to claim 15, further comprising a step of:
analyzing data distribution of the image data.

18. The content-adaptive adjustment method according to claim 13, wherein power consumption in the light-emitting display is analyzed.

19. The content-adaptive adjustment method according to claim 18, wherein an average power consumption value in the light-emitting display is obtained is obtained after the image data has been analyzed.

20. The content-adaptive adjustment method according to claim 18, further comprising step of:
analyzing data distribution of the image data.

21. The content-adaptive adjustment method according to claim 13, further comprising a step of:
determining a gain applied to each pixel value according to analyzed intensity of the image data or analyzed power consumption in the light-emitting display.

22. The content-adaptive adjustment method according to claim 21, further comprising a step of:
providing a lookup table which includes a plurality of data pairs, each representing the analyzed intensity or the analyzed power consumption and its associated gain.

23. The content-adaptive adjustment method according to claim 13, wherein said image data are adjusted by remapping with a tone curve.

24. The content-adaptive adjustment method according to claim 13, wherein drive levels of a reference-voltage generating circuit of a display driver are adjusted according to the analyzed image data.
